(19) United States
(12) Patent Application Publication
(10) Pub. No.: US 2015/0101286 A1
(43) Pub. Date: Apr. 16, 2015

(54) Beverage Jug Cleaning System and Method

(71) Applicant: Scott T. Clarkson, Seal Beach, CA (US)

(72) Inventor: Scott T. Clarkson, Seal Beach, CA (US)

(21) Appl. No.: 14/515,155

(22) Filed: Oct. 15, 2014

Related U.S. Application Data
(60) Provisional application No. 61/891,381, filed on Oct. 15, 2013.

(51) Int. Cl. B08B 9/34; B65B 55/10; B08B 9/08

(52) U.S. Cl. CPC B08B 9/34; B08B 9/0826; B65B 55/10
USPC 53/426; 134/95.3

(57) ABSTRACT

A system and method are provided for washing, sanitizing, drying, and refilling beverage bottles, such as beer growlers. The sanitizing system is either built into a counter or may be built into a portable cart. The sanitizing system organizes a wash, rinse, sanitizing, and carbon dioxide nozzles in order of use within a drain basin, so that the operator can quickly and reliably move from one nozzle at an organized cleaning station. Further, the container can be dried, filled, and chilled by the carbon dioxide nozzle, so that the refilled beer can be protected by a head of carbon dioxide, preventing oxidation. Using the present sanitizing system and method thoroughly cleans and sanitizes the beverage container, preventing adulteration of the refilled beverage.

### RELATED APPLICATION DATA

This application claims the priority date of provisional application No. 61/891,381 filed on Oct. 15, 2013.

### BACKGROUND OF THE INVENTION

1. Field

The present system and method relates to cleaning beverage containers, and more particularly, to a system and method for quickly cleaning and sanitizing beverage jugs as the customer awaits.

2. Description of the Related Art

Craft beers have gained wide popularity in recent years. These beers are often sold directly to consumers from the breweries, brewpubs, or other vendors in take-home jugs, called growlers. Growlers are generally made from glass, ceramic, or stainless steel, with a narrow mouth through which the fluid is filled and dispensed and a neck enlarging to a large body to contain the beer or other beverage. The mouth or opening is generally sealed with a screw-on cap or a hinged porcelain gasket cap. Glass growlers are generally made with clear, amber, or other colored glass. Further, growlers may have a handle integrally molded with one or both the body and neck.

In use, the growler may be purchased by the consumer at the time of the first filling or by deposit. The growler is usually filled with beer or other beverage directly from the tap. The beverage is taken home with the consumer for consumption. A deposit encourages the consumer to bring the growler back to the vendor for refilling. Before refilling, it is highly recommended that the vendor clean the growler, sometimes to comply with local health and safety regulations and to maintain the integrity of the refilled product. If contaminants are remaining in the growler, the newly added beverage may be negatively affected such that quality and taste are reduced. Further, empty containers are often depositories for various liquids and effluents that are generally unsafe or undesirable. Additionally, if the consumer leaves a small amount of old beverage in the growler, the growler may develop a foul smell, often called a “skunky” smell.

Thus, a substantial problem for vendors is insuring the growlers are properly cleaned before refilling. Cleaning growlers is exacerbated by their construction, as the growler has a narrow mouth through which all of the cleaning must be effectuated. The large body is difficult to clean with basic tools and cleaning techniques, leaving portions of the inner wall contaminated. Furthermore, the vendor may have difficulty determining whether the cleaning process has been effective, as amber growlers are difficult to inspect. Moreover, the consumer is generally waiting for the growler to be cleaned and refilled, thus necessitating a quick, and often ineffective, cleaning.

Thus, what is needed is a means for cleaning growlers at the point of dispense by the vendor. The means should provide a consistent level of cleanliness by a using an easy-to-follow method of cleaning which takes a minimal amount of time. Further, the equipment should work seamlessly behind the bar, using existing facilities.

### SUMMARY OF THE INVENTION

A cleaning system is provided for cleaning the interior of a beverage container with an interior wall and a mouth, optionally a jug or the like. In a preferred embodiment, the sanitizing system has a basin with a drain through a bottom pan for disposing of waste fluids collected within the basin. A wash nozzle, a rinse nozzle adjacent to the wash nozzle, a sanitizer nozzle adjacent to the rinse nozzle, and a compressed gas nozzle adjacent to the sanitizing nozzle all extending from the bottom pan of the basin. The wash nozzle is fluidly connected to a detergent agent source which supplies a detergent agent. The rinse nozzle is fluidly connected to a water source which supplies rinse water. The sanitizer nozzle is fluidly connected to a sanitizing agent source which supplies a sanitizing agent. The gas nozzle is connected to a compressed gas source which supplies a compressed gas, such as carbon dioxide, nitrogen, or argon.

In use, the operator holds the beverage container in an inverted orientation with the mouth over the wash nozzle to inject a detergent agent spray into the beverage container for coating the interior wall with the detergent agent. The operator holds the beverage container in the inverted orientation with the mouth over the rinse nozzle to inject a water spray into the beverage container for rinsing the detergent agent or contaminants from the interior wall. The operator holds the beverage container in the inverted orientation with the mouth over the sanitizer nozzle to inject a sanitizing agent spray into the beverage container for coating the interior wall with the sanitizing agent. The operator holds the beverage container in the inverted orientation with the mouth over the compressed gas nozzle to inject a gas into the beverage container for dislodging at least some of the sanitizing agent from the interior.

Optionally, the basin is a recessed area on a work surface with a basin cover fitted over the recessed area. The basin cover has a plurality of perforations or a grating for allowing waste liquid to drain through to the basin. The basin cover further has a wash nozzle opening that permits the injecting of the detergent agent spray into the mouth, a rinse nozzle opening that permits the injecting of the water spray into the mouth, a sanitizing nozzle opening that permits the injecting of the sanitizing agent spray into the mouth, and a compressed gas nozzle opening that permits the injecting of the gas into the mouth.

An optional detergent chemical injector proportionally combines water from the water source with a detergent concentrate to produce the detergent agent. The detergent agent source may be a detergent mixing chamber, where the detergent mixing chamber fluidly connects and is situated between the detergent chemical injector and the wash nozzle. The water and the detergent concentrate mix within the detergent mixing chamber, with a wash nozzle line delivering the detergent agent to the wash nozzle.

An optional sanitizing chemical injector proportionally combines water from the water source with a sanitizer concentrate to produce the sanitizing agent. The sanitizing agent source may be a sanitizer mixing chamber, where the sanitizer mixing chamber fluidly connects and is situated between the sanitizing chemical injector and the sanitizing nozzle. The water and the sanitizer concentrate mix within the sanitizer mixing chamber, with a sanitizer nozzle line delivering the sanitizer agent to the sanitizer nozzle.

Optionally, the compressed gas is a compressed carbon dioxide gas and the compressed gas source is a high-pressure gas cylinder. The basin is supported within one of a stationary support and a portable support.

Optionally, the wash nozzle, the rinse nozzle, the sanitizer nozzle, and the compressed gas nozzle are each normally closed push actuated valves with an actuator extending radially to receive the mouth of the beverage container. A spray nozzle is centrally situated relative to the actuator. The spray nozzle is actuated by pushing the mouth of the container on the actuator to push the actuator down.

A method of cleaning, drying, and filling a beverage container is additionally provided. A basin is provided with a drain through a bottom pan, with a wash nozzle, a rinse nozzle, a sanitizer nozzle, and a compressed gas nozzle each extending upwardly from the bottom pan. The wash nozzle is actuated by pushing the beverage container down onto the wash nozzle while the beverage container is inverted to spray the interior through the mouth with a detergent agent, to coat the interior wall with the detergent agent. The rinse nozzle is actuated by pushing the beverage container down onto the rinse nozzle while the beverage container is inverted to spray the interior through the mouth with water, to rinse the interior wall with water to substantially remove the detergent agent. The sanitizer nozzle is actuated by pushing the beverage container down onto the sanitizer nozzle while the beverage container is inverted to spray the interior through the mouth with a sanitizing agent, to coat the interior wall with the sanitizing agent

In the drying process, the compressed gas nozzle is actuated by pushing the beverage container down onto the compressed gas nozzle while the beverage container is inverted to spray the interior through the mouth with a compressed gas, to dislodge the sanitizing agent from the interior wall. The beverage container is placed in the inverted orientation on a drying rack until the interior wall is substantially dry.

In the filling process, the compressed gas nozzle is actuated a second time by pushing the beverage container down onto the compressed gas nozzle while the beverage container is inverted to spray the interior through the mouth with a gas such that the interior is substantially filled with the gas. The beverage container is uprighted to trap the gas within the beverage container. The beverage container is filled with a beverage to leave a small portion of the gas atop the beverage. The mouth of the beverage container is capped to seal the beverage and gas within the interior of the beverage container. As an option, the compressed gas may be a heavier-than-air gas, such as carbon dioxide.

An optional step includes, actuating the compressed gas nozzle for an extended time such that both the interior is substantially filled with the carbon dioxide and the beverage container is substantially reduced in temperature. The step of filling the beverage container with a beverage may further include the step of displacing all the air from the filled container with the carbon dioxide to prevent oxidation of the beverage.

### BRIEF DESCRIPTION OF THE SEVERAL VIEWS OF THE DRAWINGS

FIG. 1 is a perspective view of the preferred embodiment of the present sanitizing system, showing the sanitizing system installed on a mobile cart;

FIG. 2 is a process diagram of the preferred embodiment of the present sanitizing system;

FIG. 3 is a partial cross-sectional view of the preferred embodiment of the present sanitizing system, illustrating an exemplary spray nozzle and a partial view of an exemplary beverage container; and

FIG. 4 is a flow chart illustrating a preferred method of sanitizing a beverage container.

### LISTING OF REFERENCE NUMERALS OF FIRST-PREFERRED EMBODIMENT

sanitizing system 20
basin 22
wash nozzle 24
rinse nozzle 26
sanitizer nozzle 28
compressed gas nozzle 30
drain 32
drain line 34
bottom pan 36
side walls 38
detergent agent source 40
wash nozzle line 43
water nozzle line 44
water source 45
sanitizer nozzle line 50
compressed gas source 52
compressed gas 54
compressed gas line 56
gas 64
work surface 66
basin cover 68
basin top surface 69
perforations 70
skirt 71
wash nozzle opening 72
rinse nozzle opening 74
sanitizing nozzle opening 76
compressed gas nozzle opening 78
detergent chemical injector 80
detergent concentrate 82
detergent concentrate line 84
detergent mixing chamber 86
sanitizing chemical injector 88
sanitizer concentrate 90
sanitizer concentrate line 91
sanitizer mixing chamber 92
high-pressure gas cylinder 94
push actuated valve 96
actuator 98
spray nozzle 100
faucet 101
flexible hose 102
shutoff valve 104
filter 106
check valve 108
water pressure regulator 110
wash tee 112
rinse tee 114
cart 116
utility shelf 118
wheel 120
detergent bottle 122
sanitizer bottle 124
leg 126
base 128
top 129
gas pressure regulator 130
threaded connector 132
nut 134
gasket 136
beverage container 200
interior wall 202
mouth 204
handle 206
interior 208

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

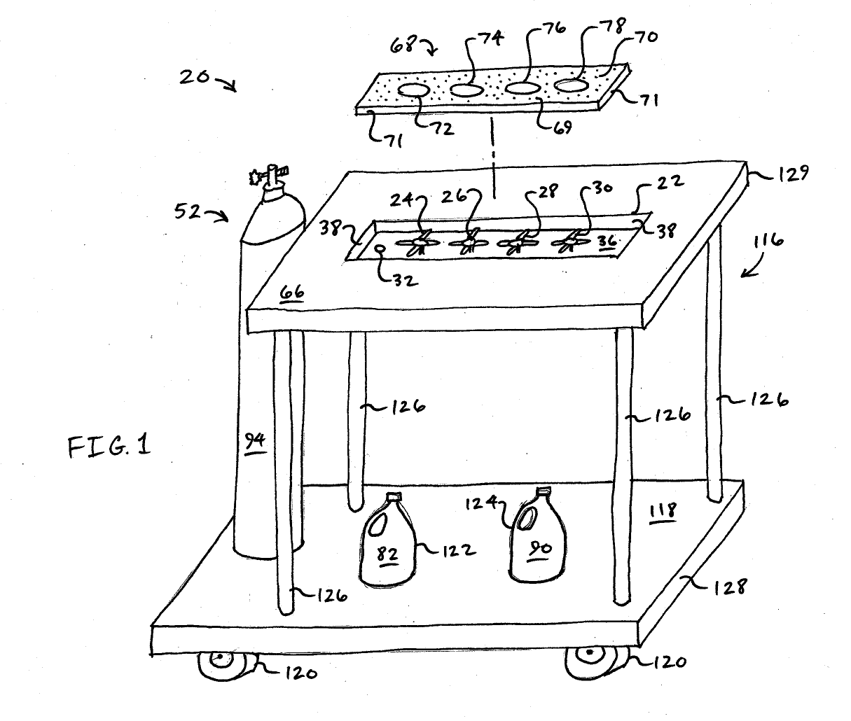

The presently described beverage jug cleaner provides an easy-to-follow system and method of cleaning growlers thoroughly and consistently. An exemplary embodiment of the present cleaning and sanitizing system (20) can be seen in FIGS. 1-3. In particular, FIG. 1 illustrates an exemplary embodiment of the present system (20) in mobile cart (116) form, which can be positioned behind a bar counter or at any location where refilling occurs. Alternatively, although not shown, the described system (20) can be easily designed as a permanent installation within a bar. Generally, the cart (116) is made from stainless steel material for durability and ease of cleaning. The cart (116) generally has a base (128) with four wheels (120) attached beneath and a utility surface (118) to permit easy transport from one location to the next. A top (129) is supported above the base (128) by four legs (126). The height of the top (129) may optionally be adjusted to be level with a nearby counter or other work surface. Equipment and consumables may be placed on utility surface (118), such as the high-pressure gas cylinder (94), the detergent bottle (122), the sanitizing bottle (124), wastewater container, tools, and the like. In this way, the cart (116) permits a fully portable system (20) with most or all equipment necessary for operation stored on-board.

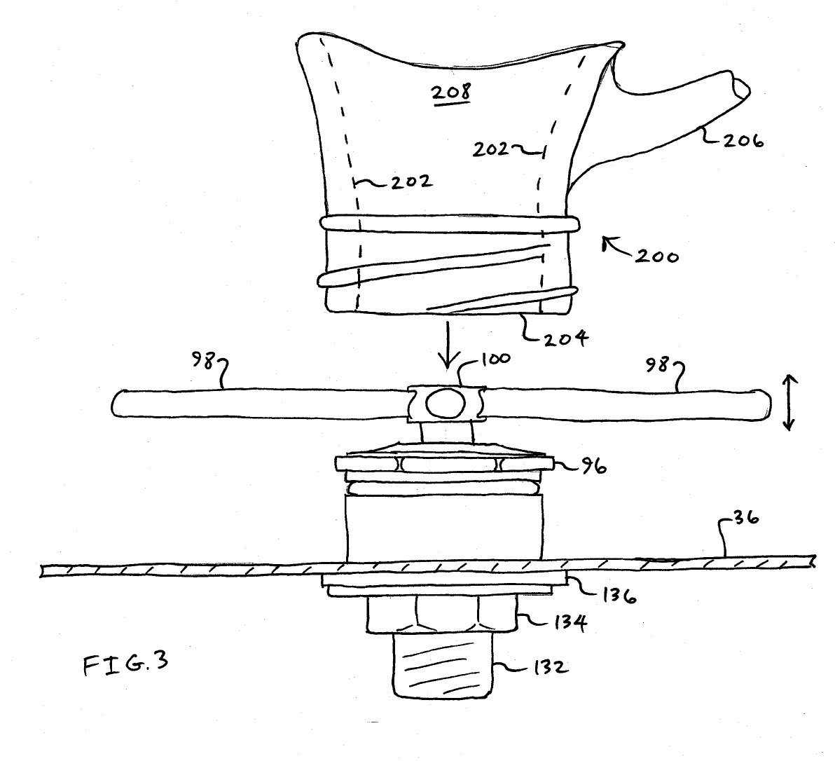

A rectangular basin (22) is formed on the work surface (66). The basin (22) has four side walls (38) and a bottom pan (36) with a drain (32) formed through the bottom pan (36) to permit drainage of waste fluid to a municipal sewage system or a waste fluid containment bottle. Four nozzles (24, 26, 28, 30) are secured through the bottom pan (36), held in place and sealed by a nut (134) and gasket (136) (as illustrated in FIG. 3). The nozzles (24, 26, 28, 30) are generally aligned, but other positioning is possible. In this example embodiment, the nozzles (24, 26, 28, 30) are in-line, with a wash nozzle (24) on the far left, next, the rinse nozzle (26), the sanitizer nozzle (28), and then, the compressed gas nozzle (30). The alignment of the nozzles (24, 26, 28, 30) permits the operator to move the beverage container or jug (200) from one nozzle to the next in quick succession during the cleaning process, in either a linear, circular, or other ergonomic or convenient pattern.

A basin cover (68) is configured to be inserted within the basin (22), where the skirt (71) of the cover (68) has a height that matches the depth of the basin (22) side walls (38), with the skirt (71) being supported on the bottom pan (36), such that the basin cover top surface (69) is flush with the work surface (66). Perforations are formed through the basin top surface (69) to permit waste fluids to flow into the basin (22) below, and then to the drain (32). When the basin cover (68) is inserted into and covering the basin (22), a wash nozzle opening (72) is situated over the wash nozzle (24), the rinse nozzle opening (74) is situated over the rinse nozzle (26), the sanitizing nozzle opening (76) is situated over the sanitizing nozzle (28), and the compressed gas nozzle opening (78) is situated over the compressed gas nozzle (30). Thus, the operator can access each nozzle (24, 26, 28, 30) when the basin cover (68) is installed over the basin (22). Further, the openings (72, 74, 76, 78) provide an additional drainage means which permits waste fluid to flow into the basin (22). Optionally, one or more openings (72, 74, 76, 78) can serve as the sole or primary drainage means.

The base (128) of the cart (116) is preferably larger than the top (129), so that the high-pressure gas cylinder (94) can rest on the base (128) and be strapped to the top (129). Further, handles may extend from the top (129) to permit pushing and positioning of the cart (116). The cart (116) may be positioned separately from the bar counter, adjacent to the counter, or may be positioned within an opening in the bar counter, where the work surface (66) is level with the bar counter.

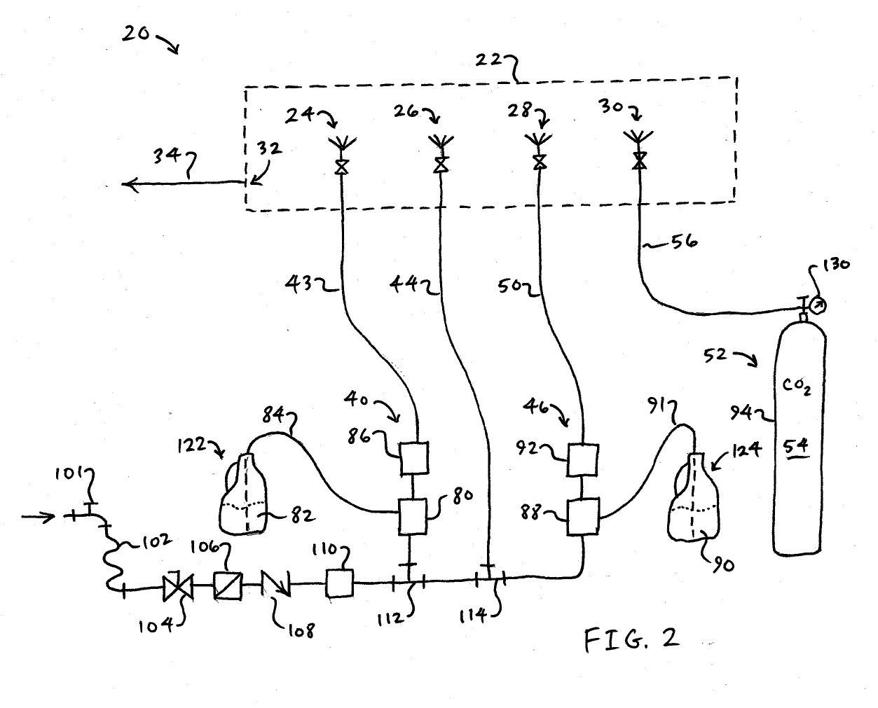

FIG. 2 illustrates one possible process diagram for carrying out the method of the present beverage sanitizing system (20). From the lower left of the figure, fresh water is introduced into the system from a faucet (101) and through a flexible hose (102), to a shut off valve (104), usually on the cart (116). An in-line filter (106) prevents debris from damaging the chemical injectors (80, 88) and adds an additional level of purity. A check valve (108) prevents chemicals from washing back into the fresh water supply. Additional check valves may be placed just upstream of the chemical injectors (80, 88) to prevent mixing of the detergent and the sanitizer; although a check valve may be integral to the chemical injectors (80, 88). The chemical injectors (80, 88) are preferably dosing pumps, such as the water-powered, non-electric chemical injector from manufacturers such as DOSATRON or MICRODOS.

Stemming from the wash tee (112) is the water supply line for the wash nozzle (24). Fresh water is received by the detergent chemical injector (80). The detergent chemical injector (80) doses the fresh water with detergent concentrate (82) through volumetric proportioning, by injecting the detergent concentrate (82), drawn from the detergent bottle (122) through the detergent concentrate line (84), into the fresh water within the detergent mixing chamber (86), where the water and detergent concentrate (82) mix at a desired proportion, which may be set by the manufacturer or the operator. The mixing chamber (86) may serve as the detergent agent source (40); or the detergent agent source (40) may be a separate container. The wash nozzle line (43) carries the detergent agent (a blend of water and the detergent concentrate) to the wash nozzle (24). Municipal water pressure generally provides sufficient pressure to cause the detergent agent to spray from the wash nozzle (24) with sufficient velocity to spray the entire interior wall (202) of the beverage container (200). A pressure regulator may be used to reduce municipal pressure, or a pump may be used to increase pressure.

The water supply is again diverted at the rinse tee (114), where fresh water is directly delivered to the rinse nozzle (26) through rinse nozzle line (44). Fresh water is delivered to the sanitizing chemical injector (88), where sanitizing concentrate (90) is drawn from sanitizer bottle (124) through sanitizer concentrate line (91). In the same way as the detergent chemical injector (80), the sanitizing chemical injector (88) injects a desired proportion of sanitizer concentrate (90) into the fresh water, and the two are mixed within the sanitizing mixing chamber (92), which may act as the sanitizing agent source (46). The sanitizing agent is carried to the sanitizer nozzle (28) through sanitizer nozzle line (50). Although the fresh water is divided into separate flows through use of tees (112, 114), fresh water may be divided at a manifold, to provide water to the detergent chemical injector (80), the rinse nozzle (26), and the sanitizer chemical injector (80).

Compressed gas (54), preferably carbon dioxide, is stored in a compressed gas source (52), which preferably is a high-pressure gas cylinder (94) (e.g., at approximately 800 psi) or bulk low-pressure systems, such as an existing 300 psi CO2 soda system. The gas pressure regulator (130) reduces the pressure of the compressed gas (54) to a desired level, delivering the gas (54), at a reduced pressure, to the compressed gas nozzle (30), through compressed gas line (56).

FIG. 3 illustrates an example nozzle (24, 26, 28, 30) that may be used with the present system (20). The nozzle is a normally closed, push actuated-type nozzle (96), which sprays liquid or gas from the spray nozzle (100) when actuated. The actuator (98) may be star shaped, with multiple rods extending radially from a central hub. Within the central hub is an opening to permit the spray nozzle (100) to spray a liquid or gas into the beverage container (200), a jug or growler in this case. The push actuated valve (96) is inserted through an opening in the bottom pan (36) of the basin (22), and held in sealed engagement by tightening a nut (134) to compress a gasket (136). A threaded connector (136) may receive in threaded engagement a female pipe connector, a quick disconnect coupler, or similar fluid or gas line connection.

To actuate the push actuated valve (96), the operator inverts the container (200), so that the mouth (204) is downwardly directed towards the spray nozzle (100). The operator generally hold the container (200) by the body or handle (206), and pushes down on the container (200), causing the mouth (204) to push down the actuator (98). When the actuator (98) is pushed down, the valve (96) is opened to permit the liquid or gas to spray forth from the spray nozzle (100). Various spray nozzles (100) may be chosen to obtain a desired spray pattern, such as a cone-shaped spray, a jet, a combination of the two, or other desired pattern which will sufficiently coat the interior wall (202) of the container (200) and/or dislodge debris and contaminants from the interior wall (202). The operator may choose to push the beverage container (200) down upon the actuator (98) in one, continuous push or pulse the spray by pushing down on the actuator (98) and releasing it in repeated steps.

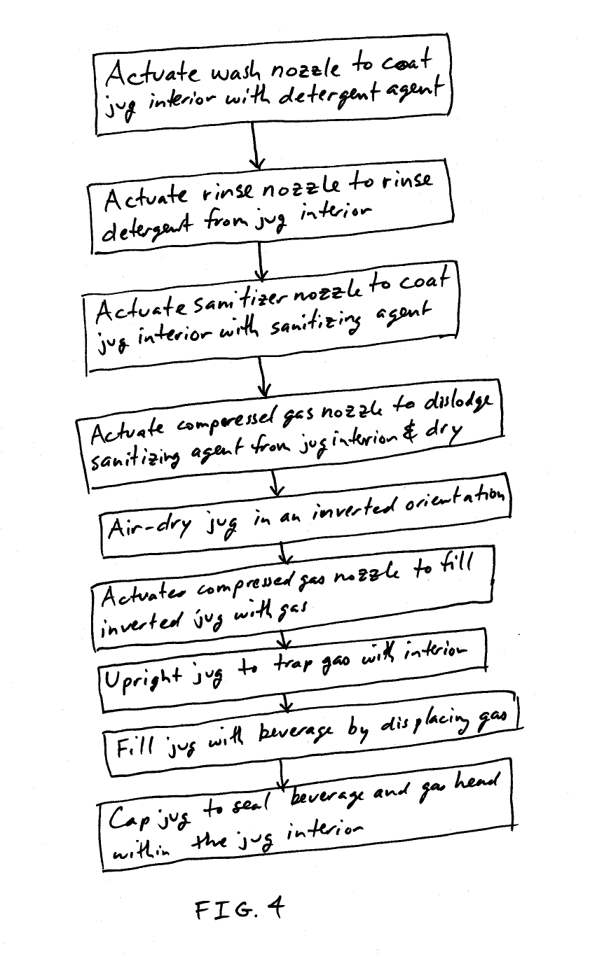

A method of sanitizing beverage containers (200) is illustrated in the flow chart of FIG. 4. There are three major processes involved, the cleaning or sanitizing process, the drying process, and the filling process. The steps of the present method include the use of the above-described sanitizing system (20). The operator receives a reusable beverage container (200) from the customer, which is presumed to be contaminated, and thus, must be cleaned. In the wash process, the operator inverts the container (200), the jug illustrated in FIG. 3, and positions the mouth (204) over the wash nozzle (24). By pushing down on the jug (200), the mouth (204) pushes down on the actuator (98), causing the detergent agent to spray from the spray nozzle (100). The spray pattern of the spray nozzle (100) and the actuation time are configured to fully coat the interior wall (202) with the detergent agent and to dislodge contaminants. Excess detergent agent will flow out of the mouth (204), draining through the perforations (70) or the wash nozzle opening (72).

Next, while the jug (200) is inverted, the operator actuates the rinse nozzle (26) by pushing on the associated actuator (98) with the mouth (204) of the jug (200). The jug (200) is generally kept in an inverted orientation from one nozzle to the next. However, the operator may upright the jug (200) between nozzles for inspection or agitation of fluid in the jug (200). The purpose of rinsing is to remove most or all of the detergent agent from the interior wall (202) of the jug (200). Thus, the spray pattern and actuation time may be adjusted to remove the detergent agent to a desired degree.

Again, while inverting the jug (200), the operator positions the mouth (204) of the jug (200) over the sanitizer nozzle (28), and actuates the sanitizer nozzle (28) by push down on the associated actuator (98). The sanitizing agent further cleans and disinfects the interior wall (204) of the jug (200). Thus, the spray pattern and actuation time may be adjusted to properly coat the interior wall (204) for the desired level of disinfection.

To start the drying process, the operator holds the mouth (204) of the inverted jug (200) over the compressed gas nozzle (30), pushing the mouth (204) down on the associated actuator (98). The gas jets forth from the spray nozzle (100) with sufficient velocity to dislodge much of the sanitizing agent from the interior wall (202) and to accelerate evaporation. The excess sanitizing agent drains from the mouth (204) and into the basin (22). The jug (200) is set aside to complete the drying process in the inverted orientation on a drying rack, permitting the remainder of the sanitizing agent to drain or evaporate.

After drying, the jug (200) is again inverted, and the mouth (204) is aligned with the spray nozzle (100) of the compressed gas nozzle (30). Then, in a similar manner as described above, the mouth (204) of the jug (200) is pushed down on the actuator (98) to spray the gas in decompressed form into the jug (200) interior. Upon exiting the gas nozzle (30) the compressed gas (54) experiences rapid pressure and temperature drops. As discussed, the preferred compressed gas (54) is a carbon dioxide medium, stored in liquid and gas form within a high-pressure gas cylinder (94) or other appropriate high or low pressure gas source. As the carbon dioxide is released through the orifice of the spray nozzle (100), the decrease in temperature causes the exiting gas to change phase to solid carbon dioxide, or dry ice. Thus, cold carbon dioxide gas and flakes of solid carbon dioxide impinge or otherwise contact the inner wall (202) of the jug (200) forming a layer of frost, which may include the solid carbon dioxide and frozen ambient moisture, which chills the jug (200). The solid carbon dioxide quickly sublimates under atmospheric conditions causing further chilling of the jug (200). A further advantage of the carbon dioxide injection is an effect known as “snow cleaning”, where the injected carbon dioxide removes any remaining particles and organic residues.

Injected carbon dioxide gas and sublimated carbon dioxide fill the jug (200) interior (208) with carbon dioxide gas. The point at which a particular jug (200) is filled may be determined experimentally, and may depend on such factors as the volume of carbon dioxide exiting the nozzle (100), the volume of the jug (200), the shape of the jug (200), or other factors. Once the jug (200) is filled with carbon dioxide gas, the operator immediately uprights the jug (200), so that the heavier-than-air gas is trapped in the jug (200) interior (208).

The operator then transports the upright and chilled jug (200) to the filling tap, where beer or other beverage is introduced into the jug (200) through the mouth (204). As the jug (200) interior (208) is filled with the beverage, the liquid displaces the carbon dioxide gas within the interior (208), forcing the gas out of the mouth (204) throughout the filling process. Once the jug (200) is filled, the carbon dioxide occupies just the small volume of empty space between the upper surface of the beverage and the mouth (204) of the jug (200), creating a head that protects the beverage from oxidation and other contaminants in the air. Once a cap is secured to the mouth (204), the carbon dioxide is trapped within.

While particular forms of the invention have been illustrated and described, it will also be apparent to those skilled in the art that various modifications can be made without departing from the spirit and scope of the invention. Accordingly, it is not intended that the invention be limited except by the claims.

What is claimed is:

1. A sanitizing system for cleaning an interior of a beverage container by an operator, the beverage container having an interior wall and a mouth, the system comprising:
a basin with a drain through a bottom pan for disposing of waste fluids collected within the basin;
a wash nozzle extending from the bottom pan of the basin, the wash nozzle fluidly connected to a detergent agent source supplying a detergent agent;
a rinse nozzle extending from the bottom pan of the basin and adjacent to the wash nozzle, the wash nozzle fluidly connected to a water source supplying water;
a sanitizer nozzle extending from the bottom pan of the basin and adjacent to the rinse nozzle, the sanitizer nozzle fluidly connected to a sanitizing agent source supplying a sanitizing agent;
a compressed gas nozzle extending from the bottom pan of the basin and adjacent to the sanitizing nozzle, the compressed gas nozzle fluidly connected to a compressed gas source supplying a compressed gas;
wherein the operator holds the beverage container in an inverted orientation with the mouth over the wash nozzle to inject a detergent agent spray into the beverage container for coating the interior wall with the detergent agent;
and wherein the operator holds the beverage container in the inverted orientation with the mouth over the rinse nozzle to inject a water spray into the beverage container for rinsing the detergent agent from the interior wall;
and wherein the operator holds the beverage container in the inverted orientation with the mouth over the sanitizer nozzle to inject a sanitizing agent spray into the beverage container for coating the interior wall with the sanitizing agent;
and wherein the operator holds the beverage container in the inverted orientation with the mouth over the compressed gas nozzle to inject a gas into the beverage container for dislodging at least some of the sanitizing agent from the interior.

2. The sanitizing system of claim 1, wherein the basin is a recessed area on a work surface, a basin cover is fitted over the recessed area, the basin cover comprising:
a plurality of perforations for allowing waste liquid to drain through to the basin,
a wash nozzle opening that permits the injecting of the detergent agent spray into the mouth;
a rinse nozzle opening that permits the injecting of the water spray into the mouth;
a sanitizing nozzle opening that permits the injecting of the sanitizing agent spray into the mouth; and
a compressed gas nozzle opening that permits the injecting of the gas into the mouth.

3. The sanitizing system of claim 1, wherein a detergent chemical injector proportionally combines water from the water source with a detergent concentrate to produce the detergent agent.

4. The cleaning or sanitizing system of claim 3, wherein the detergent agent source is a detergent mixing chamber, the detergent mixing chamber fluidly connecting and situated between the detergent chemical injector and the wash nozzle, the water and the detergent concentrate mixing within the detergent mixing chamber, a wash nozzle line delivering the detergent agent to the wash nozzle.

5. The sanitizing system of claim 1, wherein a sanitizing chemical injector proportionally combines water from the water source with a sanitizer concentrate to produce the sanitizing agent.

6. The sanitizing system of claim 5, wherein the sanitizing agent source is a sanitizer mixing chamber, the sanitizer mixing chamber fluidly connecting and situated between the sanitizing chemical injector and the sanitizing nozzle, the water and the sanitizer concentrate mixing within the sanitizer mixing chamber, a sanitizer nozzle line delivering the detergent agent to the wash nozzle.

7. The sanitizing system of claim 1, wherein the compressed gas is a compressed carbon dioxide gas and the compressed gas source is a high-pressure gas cylinder.

8. The sanitizing system of claim 1, wherein the wash nozzle, the rinse nozzle, the sanitizer nozzle, and the compressed gas nozzle are each a normally closed push actuated valve with an actuator extending radially to receive the mouth of the beverage container, a spray nozzle is centrally situated relative to the actuator, wherein the spray nozzle is actuated by pushing the mouth of the container on the actuator to push the actuator down.

9. The sanitizing system of claim 1, wherein the beverage container is a jug.

10. The sanitizing system of claim 1, wherein the basin is supported within one of a stationary support and a portable support.

11. A method of cleaning and filling a beverage container, the beverage container having an interior wall and a mouth, the method comprising the steps of:
providing a basin with a drain through a bottom pan, a wash nozzle, a rinse nozzle, a sanitizer nozzle, and a compressed gas nozzle each extending upwardly from the bottom pan;
actuating the wash nozzle by pushing the beverage container down onto the wash nozzle while the beverage container is inverted to spray the interior through the mouth with a detergent agent;
coating the interior wall with the detergent agent;
actuating the rinse nozzle by pushing the beverage container down onto the rinse nozzle while the beverage container is inverted to spray the interior through the mouth with water;
rinsing the interior wall with water to substantially remove the detergent agent;
actuating the sanitizer nozzle by pushing the beverage container down onto the sanitizer nozzle while the beverage container is inverted to spray the interior through the mouth with a sanitizing agent;
coating the interior wall with the sanitizing agent;
actuating the compressed gas nozzle by pushing the beverage container down onto the compressed gas nozzle while the beverage container is inverted to spray the interior through the mouth with a compressed gas;
dislodging substantially the sanitizing agent from the interior wall with the compressed gas;
placing the beverage container in the inverted orientation on a drying rack until the interior wall is substantially dry;
actuating the compressed gas nozzle a second time by pushing the beverage container down onto the compressed gas nozzle while the beverage container is inverted to spray the interior through the mouth with a gas such that the interior is substantially filled with the gas;
uprighting the beverage container; and
filling the beverage container with a beverage to leave a small portion of the gas atop the beverage; and
capping the mouth to seal the beverage and gas within the beverage container.

12. The method of claim 11, wherein the gas is carbon dioxide.

13. The method of claim 12, wherein the step of actuating the compressed gas nozzle a second time, further comprises the step of:
actuating for an extended time the compressed gas nozzle such that both the interior is substantially filled with the carbon dioxide and the beverage container is substantially reduced in temperature.

14. The method of claim 12, wherein the step of filling the beverage container with a beverage further comprises the step of displacing all the air from the filled container with the carbon dioxide to prevent oxidation of the beverage.
